(19) United States
(12) Patent Application Publication
(10) Pub. No.: US 2026/0003727 A1
(43) Pub. Date: Jan. 1, 2026

(54) SCALABLE ARCHITECTURE FOR CONFIGURABLE DYNAMIC ERROR CORRECTION CODING (ECC) MEMORY

(71) Applicant: QUALCOMM Incorporated, San Diego, CA (US)

(72) Inventors: Sateeshkumar INJARAPU, Bangalore (IN); Amit DUGGAL, Bangalore (IN); Manish Kumar SAXENA, Bangalore (IN); Nitin JAISWAL, Bangalore (IN); Ishwarya ARUMUGAM, Coimbatore - Pollachi (IN)

(21) Appl. No.: 18/758,859

(22) Filed: Jun. 28, 2024

(51) Int. Cl. G06F 11/10

(52) U.S. Cl. CPC G06F 11/1004

(57) ABSTRACT

Aspects of the disclosure are directed to dynamic error correction coding (ECC) disable control. In accordance with one aspect, the disclosure includes assigning each of a plurality of control status registers (CSRs) to each of a plurality of memory groups referenced by a group index to an indicator for error correction coding (ECC) disablement; and performing a dynamic ECC disablement for a plurality of data words for writing to one of the plurality of memory groups according to the indicator in an assigned each of the plurality of CSRs.

### TECHNICAL FIELD

This disclosure relates generally to the field of automotive electronics, and, in particular, to configurable dynamic error correction coding (ECC) memory in automotive computing systems.

### BACKGROUND

An automotive computer requires high performance with efficient resource utilization. One key issue in efficient resource utilization is the presence of error correction coding (ECC) memories in the automotive compute. ECC memories are more robust against data errors but add significant dc power overhead to operational scenarios. Therefore, a scalable architecture for configurable dynamic ECC memories are desired in automotive computing systems.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides dynamic error correction coding (ECC) disable control. Accordingly, disclosed is an apparatus including: an indicator configured to implement an error correction coding (ECC) disablement; and a finite state machine (FSM) coupled to the indicator configured to assign each of a plurality of control status registers (CSRs) to each of a plurality of memory groups with the indicator.

In one example, the apparatus further includes a syndrome memory coupled to the FSM, the syndrome memory configured to implement a dynamic error correction coding (ECC) disablement of a plurality of data words according to the indicator. In one example, the dynamic ECC disablement suppresses a syndrome word generation for each of the plurality of data words. In one example, the indicator is governed by a compute workload. In one example, the compute workload utilizes only an arithmetic logical unit (ALU) and a memory. In one example, the apparatus further includes a data memory coupled to the FSM, the data memory configured to store the plurality of data words.

Another aspect of the disclosure provides an apparatus for dynamic error correction coding (ECC) disable control, the apparatus including: means for partitioning a plurality of memories in an automotive electronics system into a plurality of memory groups based on a plurality of control status registers (CSRs); means for initializing a group index to zero; and means for assigning each of the plurality of CSRs to each of the plurality of memory groups referenced by the group index with an indicator for error correction coding (ECC) disablement.

In one example, the apparatus further includes: means for loading a plurality of data words destined to be written into the each of the plurality of memory groups, wherein the plurality of data words is loaded into at least one pseudo register; and means for incrementing the group index by unity and means for comparing the group index to a maximum group index. In one example, the apparatus further includes means for transferring the plurality of data words from the at least one pseudo register to one of the plurality of memory groups. In one example, the apparatus further includes means for performing a dynamic ECC disablement for the plurality of data words for writing to the one of the plurality of memory groups according to the indicator in an assigned each of the plurality of CSRs.

Another aspect of the disclosure provides a method including: assigning each of a plurality of control status registers (CSRs) to each of a plurality of memory groups referenced by a group index to an indicator for error correction coding (ECC) disablement; and performing a dynamic ECC disablement for a plurality of data words for writing to one of the plurality of memory groups according to the indicator in an assigned each of the plurality of CSRs.

In one example, the indicator is governed by a workload. In one example, the workload is a graphics workload or a compute workload. In one example, the method further includes disabling an error correction coding (ECC) functionality for a memory of the plurality of the memory groups if the indicator is asserted for the memory. In one example, a disabled error correction coding (ECC) functionality suppresses a syndrome word generation for each of the plurality of data words.

In one example, the method further includes loading the plurality of data words, wherein the plurality of data words is loaded into at least one pseudo register. In one example, the method further includes incrementing the group index by unity and comparing the group index to a maximum group index. In one example, the method further includes transferring the plurality of data words from the at least one pseudo register to one of the plurality of memory groups. In one example, the method further includes partitioning a plurality of memories into the plurality of memory groups based on the plurality of CSRs. In one example, the method further includes initializing the group index to zero.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example application selection module in automotive electronics.

FIG. 3 illustrates an example architecture with dynamic control of error correction coding (ECC) functionality.

FIG. 4 illustrates an example dynamic error correction coding (ECC) disable control finite state machine (FSM).

FIG. 5 illustrates an example memory disable index table.

FIG. 6 illustrates an example application disable index table.

FIG. 7 illustrates an example memory utilization table.

FIG. 8 illustrates an example memory power savings table for dynamic error correction coding (ECC) disable control.

FIG. 9 illustrates an example flow diagram for dynamic error correction coding (ECC) disable control.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

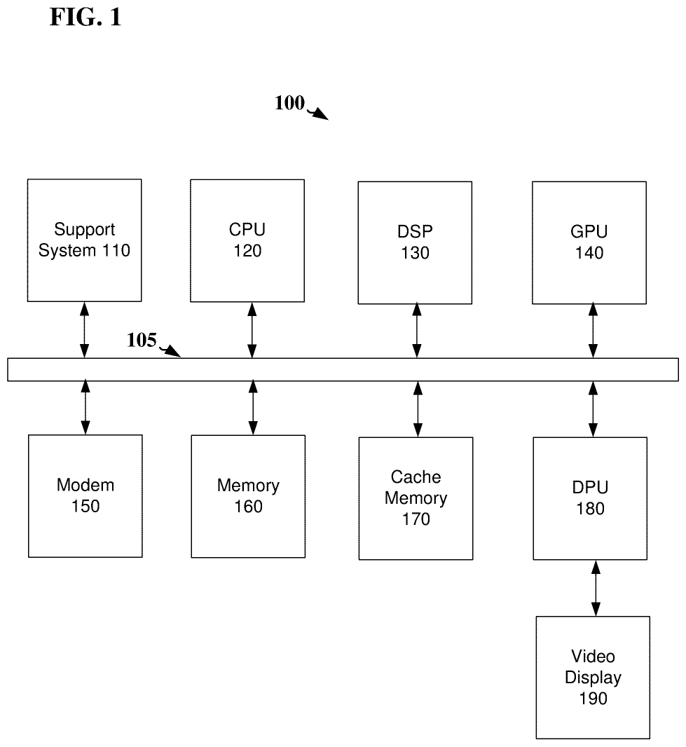

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

In an automotive computing system, a plurality of memories may be required to support storage of data words for a plurality of processors. In one example, a data word is an associated group of bits having a word size. In many scenarios, the plurality of memories requires additional error correction coding (ECC) circuitry or functionality for resiliency against various types of errors. ECC functionality is used to compute a syndrome word (e.g., parity bits) for every data word. In one example, the syndrome word is mathematically computed for the data word according to a defined ECC algorithm. In one example, if the data word is corrupted, the data word may be recovered using the information associated with the syndrome word. That is, the syndrome word allows error detection and correction to allow recovery from corruption or errors in the data word. Usage of ECC functionality in a memory improves data accuracy, but requires additional dc power consumption of its usage.

In one example, the automotive computing system may include high performance processors (e.g., a GPU) along with a plurality of memory devices (e.g., greater than 1000 memory devices). In one example, the plurality of memory devices may be error protected using ECC functionality independent of the application or use case being processed.

In one example, a graphics processing unit (GPU) in automotive electronics may have at least two use cases: graphics and compute. In one example, the compute workload (a.k.a., compute use case) utilizes an arithmetic logical unit (ALU) and memory only and a memory which is part of a graphics pipeline (i.e., a GPU memory) does not require error protection. If the GPU memory is error protected, a memory fault may result in an interrupt (e.g., GPU reset), even if error protection is not required per the application. For example, corresponding ECC functionality may consume dc power even if their functionality is not required. In one example, lack of dynamic control of ECC circuitry is limiting for many applications.

In one example, incorporation of dynamic control of ECC functionality to a particular memory may reduce dc power consumption and eliminate invalid memory faults (e.g., false ECC errors). In one example, if any device has a fault in functional safety (FuSa) logic, that device may be used for vehicle infotainment (IVI) only by globally disabling ECC functionality.

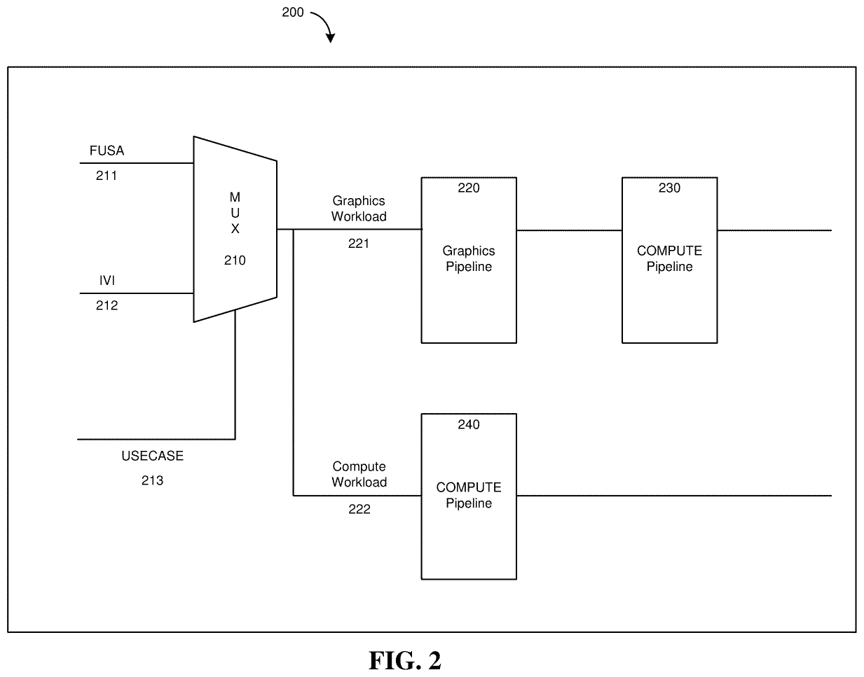

FIG. 2 illustrates an example application selection module 200 in automotive electronics. In one example, an input multiplexer (mux) 210 has a first input 211 (e.g., FuSa input) and a second input 212 (e.g., IVI input). In one example, selection between the first input 211 and the second input 212 may be controlled by a select input 213 (e.g., USECASE). For example, if the select input 213 is a binary input, then selection of a ZERO value or a ONE value in the select input 213 corresponds to selection of the first input 211 or the second output 212.

In one example, an output of the input multiplexer 210 may be a graphics workload 221 or a compute workload 222. In one example, the graphics workload 221 is processed by a graphics pipeline 220 and a first compute pipeline 230. In one example, the compute workload 222 is processed by a second compute pipeline 240.

In one example, dynamic control of ECC functionality may be implemented by incorporation of a ECC disable control signal (e.g., ecc_disable_control) for each memory of a plurality of memories. In one example, assertion of the ECC disable control signal disables syndrome memory (i.e., ECC functionality) in a memory. In one example, disablement of ECC functionality in a selected memory inhibits ECC computation for any incoming data writes for that selected memory. In one example, an ECC decoder is disabled and only data memory in the memory is operational.

In one example, dynamic control of ECC functionality may be implemented as a scalable solution of a processor with a large quantity of memories (e.g., >1000 memories). For example, usage of one control status register (CSR) per memory is not scalable and may have a large power performance and area (PPA) impact, e.g., quantified in W Hz mm². In one example, dynamic control of ECC functionality may instead be implemented with a dynamic ECC control finite state machine (FSM) and serial to parallel (S2P) and parallel to serial (P2S) decoders.

In one example, dynamic control of ECC functionality may be implemented with a quantity of control status registers (CSRs) less than a quantity of memories. For example, a quantity of 256 CSRs may be used to control an arbitrary quantity of memories. In one example, each memory of the plurality of memories may be partitioned into groups (e.g., hard macros (HM)) where each group has a quantity of memories no more than the quantity of CSRs (e.g., less than or equal to 256 memories per group). In one example, the quantity of 256 CSRs are shared across groups. In one example, each group uses the same number of CSRs in an iteration. For example, if one application disables 100 memories (e.g., 10 groups of 10 memories each), then a first group may use predefined 256 CSRs for 10 memories and other groups may use the same predefined CSRs via reprogramming. In one example, shadow registers or pseudo registers for each group may be used to store previously programmed value for each group.

In one example, a memory disable data (e.g., memory_disable_data) operation may be used to write data to memory with ECC functionality disabled for a selected group. In one example, a write to a selected group which captures the memory disable data operation may be performed in a pseudo register. In one example, once data load is completed, a memory disable data operation may be performed for another group. In one example, these steps may be repeated until all required data has been written into the plurality of memories upon completion of a load stage. In one example, a write to a transfer control register may be performed where a ONE value in the transfer control register enables a data transfer of data in the pseudo registers to ECC-disabled memory in the plurality of memories. In one example, the ECC-disabled memory is a subset of the plurality of memories where ECC functionality has been disabled.

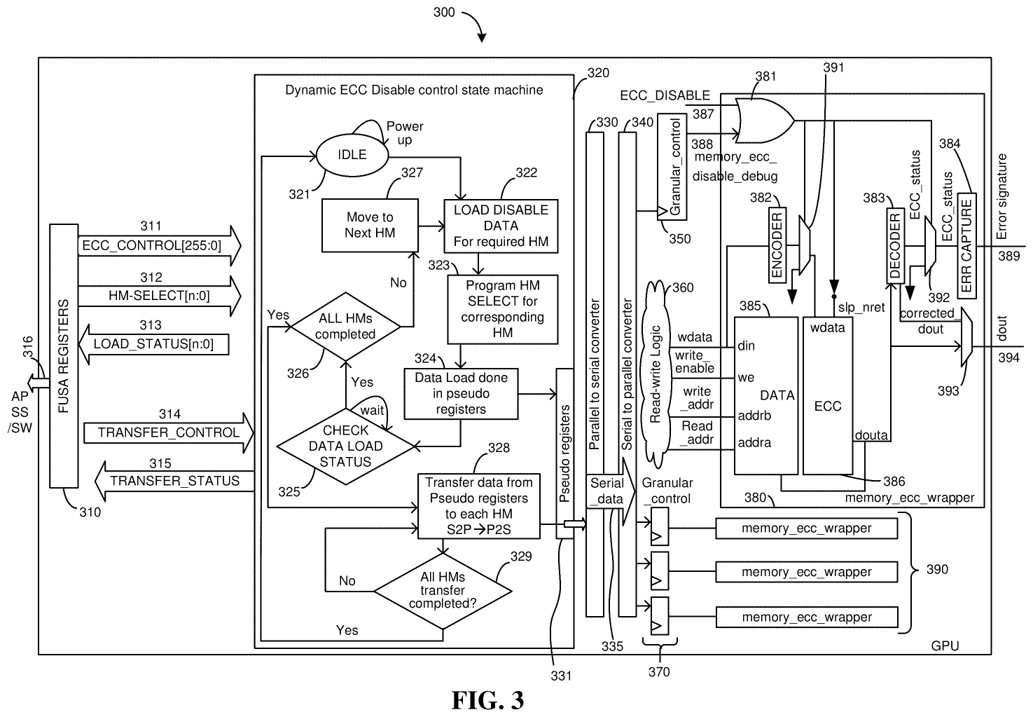

FIG. 3 illustrates an example architecture 300 with dynamic control of error correction coding (ECC) functionality. In one example, the example architecture 300 with dynamic control of ECC functionality is hosted in a GPU. In one example, the example architecture 300 with dynamic control of ECC functionality is hosted in another processor in an information processing system.

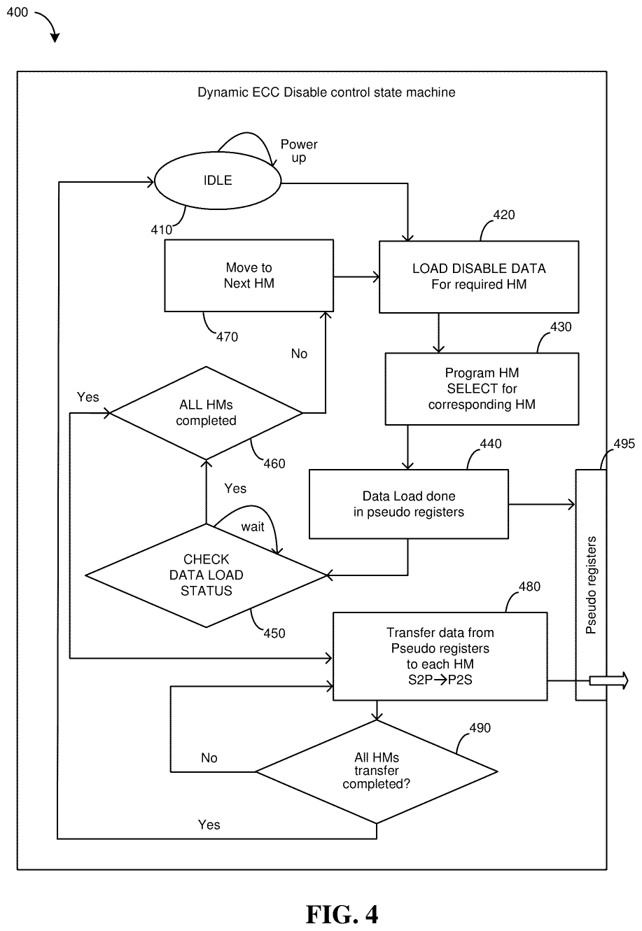

In one example, a plurality of FuSa registers 310 includes an ECC control line 311, a group select line 312, a load status line 313, a transfer control line 314, a transfer status line 315 and a software access port 316. In one example, the plurality of FuSa registers 310 interfaces with dynamic ECC disable control finite state machine (FSM) 320 which is disclosed further in FIG. 4. In one example, the dynamic ECC disable control FSM 320 is coupled to a parallel to serial (P2S) converter 330, a serial data line 335 and a serial to parallel (S2P) converter 340. In one example, a plurality of outputs from the S2P converter 340 is sent to a first granular control module 350 and a plurality of other granular control modules 370.

In one example, an ECC disable signal (e.g., ECC_DISABLE) 387 is sent to a first memory ECC wrapper module 380. In one example, the ECC disable signal 387 and a memory ECC disable debug signal 388 are sent to a logical OR gate 381 to disable ECC functionality. In one example, if either the ECC disable signal 387 or the memory ECC disable debug signal 388 is asserted (i.e., set to a ONE value), then the logical OR gate 381 output is sent to a first multiplexer 391 at an output of an ECC encoder 382. In one example, read write logic 360 writes a data word (e.g., wdata) to a data memory 385 for storage and to the ECC encoder 382 for calculation of a syndrome word for the data word. In one example, the syndrome word is next written into a syndrome memory 386 for storage. In one example, the syndrome memory 386 is an error correction coding (ECC) memory. In one example, the ECC disable signal 387 may be generated using predefined 256 CSRs which are programmed prior to application start. In one example, selection of which memory to disable may be performed by software based on the application or by hardware for independent disabling.

In one example, when the syndrome word is read out of the syndrome memory 386 under control of the read write logic 360, it is sent to an ECC decoder 383 to detect and/or correct an error in the data. In one example, the ECC decoder 383 sends an ECC status signal to an error capture module 384 if enabled by a second multiplexer 392 controlled by the logical OR gate 381 output to enable or to inhibit the ECC status signal. In one example, the error capture module 384 supplies an error signature signal 389 to indicate presence of a memory fault (e.g., memory error detected by the ECC decoder 383).

In one example, the data word from the data memory 385 is sent to a third multiplexer 393 as a final data output 394 of the first memory ECC wrapper module 380 if enabled by the third multiplexer 393 controlled by the logical OR gate 381 output to select the data word. In one example, a corrected data word from the ECC decoder 383 is sent to the third multiplexer 393 as the final data output 394 of the first memory ECC wrapper module 380 if disabled by the third multiplexer 393 controlled by the logical OR gate 381 to select the corrected data word. In one example, the functionality of the first memory ECC wrapper module 380 is replicated by a plurality of addition memory ECC wrapper modules 390.

FIG. 4 illustrates an example dynamic error correction coding (ECC) disable control finite state machine (FSM) 400. In block 410, enter an IDLE state upon power up. In block 420, load disable data for a current group of a plurality of groups (e.g., a hard macro (HM)). In block 430, program a group select operation (e.g., HM select) for the current group of the plurality of groups. In block 440, complete data load in pseudo registers 495. In block 450, check data load status. If yes, proceed to block 460. If no, wait a programmable wait interval and repeat block 450.

In block 460, check if all groups of the plurality of groups have completed data load operations. If yes, proceed to block 480. If no, proceed to block 470. In block 470, proceed to a subsequent group of the plurality of groups and continue in block 420 with the subsequent group of the plurality of groups. In block 480, transfer data from pseudo registers to each group of the plurality of groups. In block 490, check if data transfer to each group is complete. If yes, return to block 410 (i.e., IDLE state). If no, return to block 480 and continue data transfer.

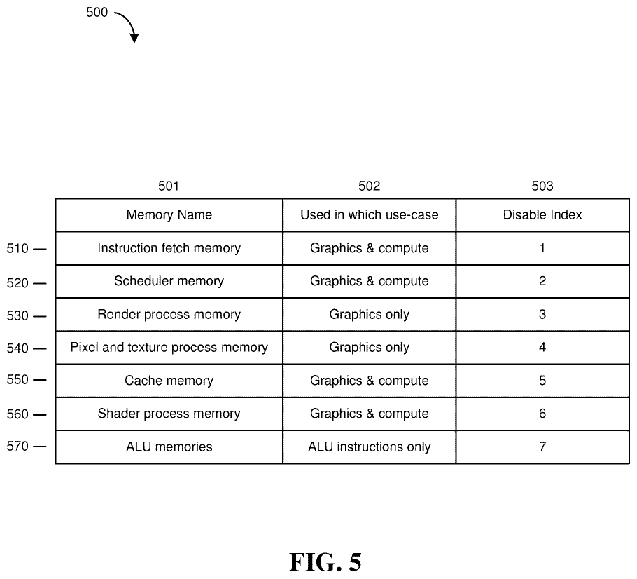

FIG. 5 illustrates an example memory disable index table 500. In one example, a first column 501 denotes a memory name, a second column 502 denotes a use case usage and a third column 503 denotes a disable index. In one example, a first row 510 lists an Instruction fetch memory for graphics and compute use cases with a disable index of 1. In one example, a second row 520 lists a Scheduler memory for graphics and compute use cases with a disable index of 2, In one example, a third row 530 lists a Render process memory for a graphics only use case with a disable index of 3. In one example, a fourth row 540 lists a Pixel and texture process memory for a graphics only use case with a disable index of 4. In one example, a fifth row 550 lists a Cache memory for a graphics and compute use case with a disable index of 5. In one example, a sixth row 560 lists a Shader process memory for a graphics and compute use case with a disable index of 6. In one example, a seventh row 570 arithmetic logical unit (ALU) memories for an ALU instructions only use case with a disable index of 7. In one example, the memory disable index table 500 may be populated based on a software application. In one example, a quantity of memories to be disabled is not a fixed quantity, and there is no priority ranking among the quantity of memories. In one example, software is aware of a workload and memory requirements for the workload to allow determination of which memories may be disabled.

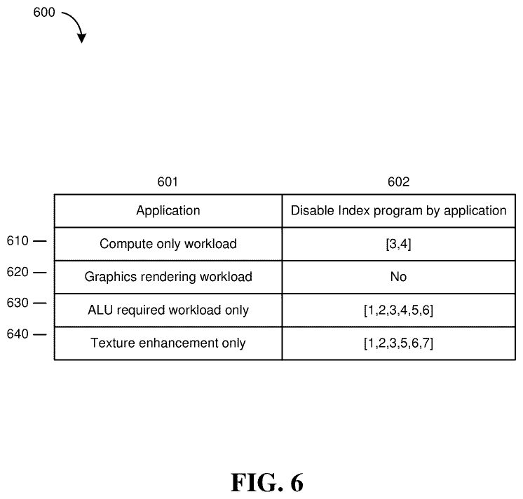

FIG. 6 illustrates an example application disable index table 600. In one example, a first column 601 denotes an application name and a second column 602 denotes a disable index program by application. In one example, a first row 610 lists a compute only workload and a disable index program of [3,4]. In one example, a second row 620 lists a graphics rendering workload with no disable index program. In one example, a third row 630 lists an arithmetic logical unit (ALU) required only workload and a disable index program of [1, 2, 3, 4, 5, 6]. In one example, a fourth row 640 lists a texture enhancement only workload and a disable index program of [1, 2, 3, 5, 6, 7]. In one example, the disable index program notation of [x, y, z, . . . ] denotes which memories may be disabled based on a software application.

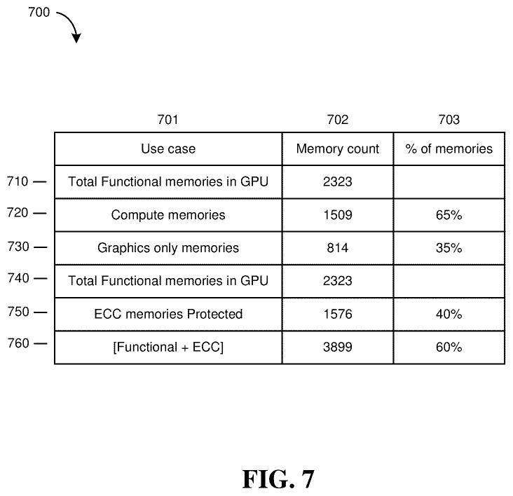

FIG. 7 illustrates an example memory utilization table 700. In one example, a first column 701 denotes a use case, a second column 702 denotes a memory count and a third column 703 denotes a percentage of memories. In one example, a first row 710 lists total functional memories in graphics processing unit (GPU) with a memory count of 2323 and non-applicable percentage of memories. In one example, a second row 720 lists compute memories with a memory count of 1509 and a percentage of memories equal to 65%. In one example, a third row 730 lists graphics only memories with a memory count of 814 and a percentage of memories equal to 35%. In one example, a fourth row 740 lists total functional memories in GPU with a memory count of 2323 and non-applicable percentage of memories. In one example, a fifth row 750 lists error correction coding (ECC) memories protected with a memory count of 1576 and a percentage of memories equal to 40%. In one example, a sixth row 760 lists functional and ECC memories with a memory count of 3899 and a percentage of memories equal to 60%. In one example, the percentage of memories signifies a percentage of disabled memories if not needed for a current workload. In one example, the percentage of disabled memories varies in real time, depending on the current workload.

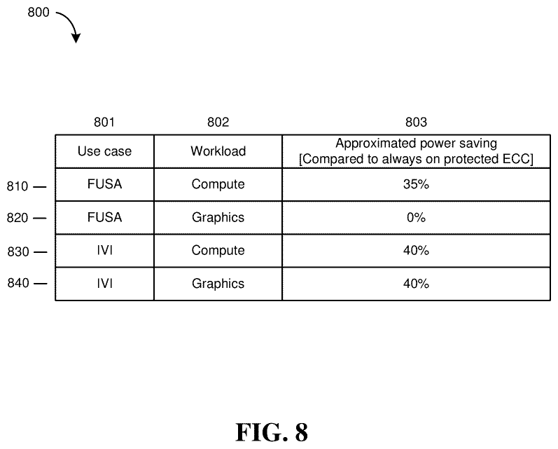

FIG. 8 illustrates an example memory power savings table 800 for dynamic error correction coding (ECC) disable control. In one example, a first column 801 denotes a use case, a second column 802 denotes a workload and a third column 803 denotes an approximate dc power savings in percent compared to an architecture with no dynamic ECC disable control. In one example, a first row 810 lists a FuSa use case with compute workload having a dc power savings of 35%. In one example, a second row 820 lists a FuSa use case with graphics workload having no dc power savings. In one example, a third row 830 lists an IVI use case with compute workload having a dc power savings of 40%. In one example, a fourth row 840 lists an IVI use case with graphics workload having a dc power savings of 40%.

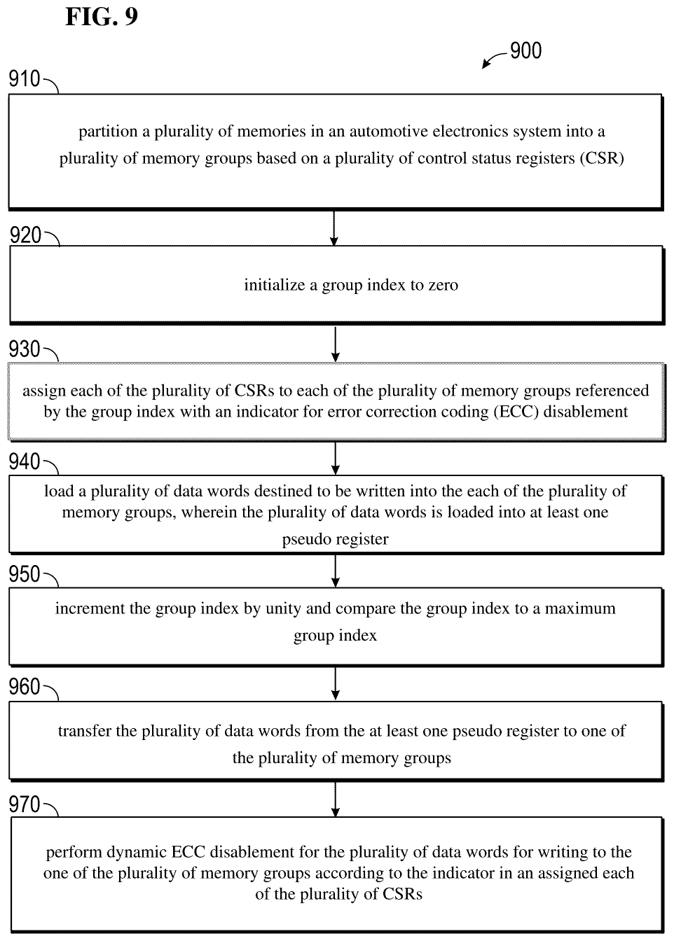

FIG. 9 illustrates an example flow diagram 900 for dynamic error correction coding (ECC) disable control. In block 910, partition a plurality of memories in an automotive electronics system into a plurality of memory groups (e.g., hard macros) based on a plurality of control status registers (CSRs). In one example, a plurality of memories in an automotive electronics system is partitioned into a plurality of memory groups (e.g., hard macros) based on a plurality of control status registers (CSRs). In one example, the plurality of memories is partitioned into the plurality of memory groups where a quantity of memories per memory group is no greater than the quantity of CSRs. In one example the quantity of CSRs is 256. In one example, the step of block 910 may be performed by a finite state machine (FSM), a processor, a CPU, a DSP, a GPU, a DPU or a combination of one or more of the mentioned entities.

In block 920, initialize a group index to zero. In one example, a group index is initialized to zero. In one example, the group index references a memory group. In one example, the group index of zero refers to a first memory group. In one example, the group index is restricted to a maximum group index determined by a quantity of memories in the plurality of memories and by the quantity of memories per memory group. In one example, the step of block 920 may be performed by a finite state machine (FSM), a processor, a CPU, a DSP, a GPU, a DPU or a combination of one or more of the mentioned entities.

In block 930, assign each of the plurality of CSRs to each of the plurality of memory groups referenced by the group index with an indicator for error correction coding (ECC) disablement. In one example, each of the plurality of CSRs is assigned to each of the plurality of memory groups referenced by the group index with an indicator for error correction coding (ECC) disablement. In one example, the indicator is governed by a workload. In one example, the workload is a graphics workload. In one example, the workload is a compute workload. In one example, the step of block 930 may be performed by a finite state machine (FSM), a processor, a CPU, a DSP, a GPU, a DPU or a combination of one or more of the mentioned entities.

In block 940, load a plurality of data words destined to be written into the each of the plurality of memory groups, wherein the plurality of data words is loaded into at least one pseudo register. In one example, a plurality of data words destined to be written into the each of the plurality of memory groups is loaded into at least one pseudo register. In one example, the loaded data words are subject to dynamic ECC disablement subsequent to release from the pseudo registers. In one example, the step of block 940 may be performed by a finite state machine (FSM), a processor, a CPU, a DSP, a GPU, a DPU or a combination of one or more of the mentioned entities. In one example, the at least one pseudo register is dedicated to one group of memories. In one example, the at least one pseudo register may hold disable data for the one group of memories. In one example, the at least one pseudo register serves as a storage device for disable data and reduces software latency of reprogramming during a sleep state.

In block 950, increment the group index by unity and compare the group index to a maximum group index. In one example, the group index is incremented by unity and is compared the group index to a maximum group index. In one example, if the group index is no greater than the maximum group index, then return to block 930. In one example, if the group index is greater than the maximum group index, proceed to block 970. In one example, the step of block 950 may be performed by a finite state machine (FSM), a processor, a CPU, a DSP, a GPU, a DPU or a combination of one or more of the mentioned entities.

In block 960, transfer the plurality of data words from the at least one pseudo register to one of the plurality of memory groups. In one example, the plurality of data words is transferred from the at least one pseudo register to one of the plurality of memory groups. In one example, the transfer employs a parallel to serial converter and a serial to parallel converter to use a serial data transport path. In one example, the step of block 960 may be performed by a data memory.

In block 970, perform dynamic ECC disablement for the plurality of data words for writing to the one of the plurality of memory groups according to the indicator in an assigned each of the plurality of CSRs. In one example, dynamic ECC disablement for the plurality of data words for writing to the one of the plurality of memory groups according to the indicator in an assigned each of the plurality of CSRs is performed.

In one example, if the indicator is asserted (e.g., with value ONE) for a given memory of each memory group, disable ECC functionality for the given memory. In one example, the disabled ECC functionality suppresses a syndrome word generation for each data word of the plurality of data words. In one example, if the indicator is de-asserted (e.g., with a value ZERO) for a given memory of each memory group, enable ECC functionality for the given memory. In one example, the enabled ECC functionality enables a syndrome word generation for each data word of the plurality of data words. In one example, the step of block 970 may be performed by a syndrome memory. In one example, the step of block 970 may be performed by a finite state machine (FSM), a processor, a CPU, a DSP, a GPU, a DPU or a combination of one or more of the mentioned entities.

In one aspect, one or more of the steps for providing dynamic error correction coding (ECC) disable control in FIG. 9 may be executed by one or more processors which may include hardware, software, firmware, etc. The one or more processors, for example, may be used to execute software or firmware needed to perform the steps in the flow diagram of FIG. 9. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
an indicator configured to implement an error correction coding (ECC) disablement; and
a finite state machine (FSM) coupled to the indicator configured to assign each of a plurality of control status registers (CSRs) to each of a plurality of memory groups with the indicator.

2. The apparatus of claim 1, further comprising a syndrome memory coupled to the FSM, the syndrome memory configured to implement a dynamic error correction coding (ECC) disablement of a plurality of data words according to the indicator.

3. The apparatus of claim 2, wherein the dynamic ECC disablement suppresses a syndrome word generation for each of the plurality of data words.

4. The apparatus of claim 1, wherein the indicator is governed by a compute workload.

5. The apparatus of claim 4, wherein the compute workload utilizes only an arithmetic logical unit (ALU) and a memory.

6. The apparatus of claim 2, further comprising a data memory coupled to the FSM, the data memory configured to store the plurality of data words.

7. An apparatus for dynamic error correction coding (ECC) disable control, the apparatus comprising:
means for partitioning a plurality of memories in an automotive electronics system into a plurality of memory groups based on a plurality of control status registers (CSRs);
means for initializing a group index to zero; and
means for assigning each of the plurality of CSRs to each of the plurality of memory groups referenced by the group index with an indicator for error correction coding (ECC) disablement.

8. The apparatus of claim 7, further comprising:
means for loading a plurality of data words destined to be written into the each of the plurality of memory groups, wherein the plurality of data words is loaded into at least one pseudo register; and
means for incrementing the group index by unity and means for comparing the group index to a maximum group index.

9. The apparatus of claim 8, further comprising means for transferring the plurality of data words from the at least one pseudo register to one of the plurality of memory groups.

10. The apparatus of claim 9, further comprising means for performing a dynamic ECC disablement for the plurality of data words for writing to the one of the plurality of memory groups according to the indicator in an assigned each of the plurality of CSRs.

11. A method comprising:
assigning each of a plurality of control status registers (CSRs) to each of a plurality of memory groups referenced by a group index to an indicator for error correction coding (ECC) disablement; and
performing a dynamic ECC disablement for a plurality of data words for writing to one of the plurality of memory groups according to the indicator in an assigned each of the plurality of CSRs.

12. The method of claim 11, wherein the indicator is governed by a workload.

13. The method of claim 12, wherein the workload is a graphics workload or a compute workload.

14. The method of claim 11, further comprising disabling an error correction coding (ECC) functionality for a memory of the plurality of the memory groups if the indicator is asserted for the memory.

15. The method of claim 14, wherein a disabled error correction coding (ECC) functionality suppresses a syndrome word generation for each of the plurality of data words.

16. The method of claim 11, further comprising loading the plurality of data words, wherein the plurality of data words is loaded into at least one pseudo register.

17. The method of claim 16, further comprising incrementing the group index by unity and comparing the group index to a maximum group index.

18. The method of claim 17, further comprising transferring the plurality of data words from the at least one pseudo register to one of the plurality of memory groups.

19. The method of claim 18, further comprising partitioning a plurality of memories into the plurality of memory groups based on the plurality of CSRs.

20. The method of claim 19, further comprising initializing the group index to zero.
